(19) United States
(12) Patent Application Publication
(10) Pub. No.: US 2026/0106810 A1
(43) Pub. Date: Apr. 16, 2026

(54) DYNAMICALLY ADJUSTING QUALITY OF SERVICE POLICY FOR AN APPLICATION SESSION

(71) Applicant: NVIDIA Corporation, Santa Clara, CA (US)

(72) Inventors: Prashant Sohani, Maharashtra (IN); Ajit Lalwani, San Jose, CA (US); Hassane Azar, Los Altos, CA (US)

(21) Appl. No.: 18/912,925

(22) Filed: Oct. 11, 2024

(51) Int. Cl. H04L 41/5025

(52) U.S. Cl. CPC H04L 41/5025

(57) ABSTRACT

Apparatuses, systems, and techniques to dynamically adjusting quality of service (QoS) policy for an application session. In at least one embodiment, performance indicators of a network used to stream the application session on the client device is used to detect a client-based network event associated with the network. The QoS policy can be modified using a set of overriding configuration properties corresponding to a type of the detected client-based network event. Contents of the application session is streamed using the QoS policy with the updated configuration parameters.

### TECHNICAL FIELD

At least one embodiment pertains to dynamically adjusting quality of service (QoS) policy for an application session according to various novel techniques described herein. For example, embodiments adjust the QoS policy to compensate for the presence of client-based network events on a network used to transmit content of the application session according to various novel techniques described herein.

### BACKGROUND

An application session (e.g., a session of a game streaming application), at a high level, involves rendering and capturing a series of frames of an application by an application server. The rendered and captured series of frames are encoded and packetized by the application server, then transmitted over a network to the client device. The client device receives and de-packetizes incoming data packets to obtain the encoded frames, which are then decoded and displayed on the client device. Typically, a quality of service (QoS) policy for the application session is used to control various server-based parameters of the encoding and transmission process (e.g., video bitrate, forward-error-correct (FEC) percentage, packet pacing, jitter buffer, etc.) to ensure a high-quality user experience.

These QoS policies include a set of rules that cover various predefined server-based network events. During the application session, client and third-party applications may interact with the network, affecting QoS and resulting in additional network events that are not covered by the QoS policies directed to server-based network events. Such additional network events referred to herein as “client-based network events” may include the existence of additional application sessions, wireless local area network (WLAN) scans, internet service provider (ISP) throttling, internet protocol (IP) transit, etc. These client-based network events, which are not covered by the QoS policy, may negatively affect the user experience.

### BRIEF DESCRIPTION OF DRAWINGS

FIG. 1 is a block diagram of an example content streaming system including a quality of service (QoS) engine for dynamically adjusting a QoS policy, in accordance with at least one embodiment;

FIG. 2 is a block diagram of an example QoS engine, in accordance with at least one embodiment;

FIG. 3 is a flow diagram of dynamically adjusting a QoS policy, in accordance with at least one embodiment;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

Embodiments described herein relate to systems and methods for dynamically adjusting quality of service (QoS) policy for an application session.

An application session (e.g., a session of a game streaming application), at a high level, involves rendering and capturing a series of frames of an application by an application server. The rendered and captured series of frames are encoded and packetized by the application server, then transmitted over a network to the client device. The client device receives and de-packetizes incoming data packets to obtain the encoded frames, which are then decoded and displayed on the client device. Typically, a quality of service (QoS) policy for the application session is used to control various server-based parameters of the encoding and transmission process (e.g., video bitrate, forward-error-correct (FEC) percentage, packet pacing, jitter buffer, etc.) to ensure a high-quality user experience.

These QoS policies include a set of rules that cover various predefined server-based network events. During the application session, client and third-party applications may interact with the network, affecting QoS and resulting in additional network events that are not covered by the QoS policies directed to server-based network events. Such additional network events referred to herein as “client-based network events” may include the existence of additional application sessions, wireless local area network (WLAN) scans, internet service provider (ISP) throttling, internet protocol (IP) transit, etc. These client-based network events, which are not covered by the QoS policy, may negatively affect the user experience.

Aspects of the present disclosure address the above and other deficiencies by detecting client-based network events as they occur and reconfiguring the QoS policy in real time based on the detected client-based network events, thereby optimizing the user experience. For example, the methods, systems, and apparatuses described herein may periodically receive network performance indicators of a network connected to a client device (e.g., connected network). An application server can use the connected network to stream content of the application session to the client device. Network performance indicators of the connected network may refer to measurable metrics that reflect the efficiency, reliability, and quality of service of the connected network. The network performance indicators may indicate the presence of a specific client-based network event. Detecting the presence of a specific client-based network event may include utilizing the network performance indicators as input for one or more mathematical models. Each mathematical model may correspond to a specific client-based network event, and may be formulated to receive the network performance indicators, and provide as output a binary decision or likelihood of the presence of the specific client-based network event on the connected network. As a result of the presence of the specific client-based network event on the connected network, a set of overriding configuration properties associated with the specific client-based network event can be used to modify a QoS policy enforced by the application server.

Accordingly, aspects of the present disclosure ensure a high-quality user by detecting client-based network events as they occur and reconfiguring the QoS policy in real time based on the detected client-based network events.

### Content Streaming System

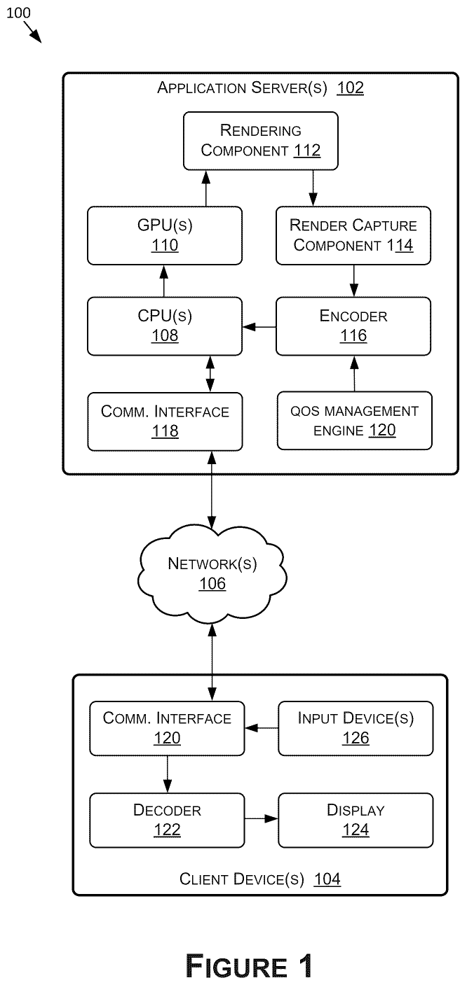

With reference to FIG. 1, an example content streaming system 100 including a quality of service (QoS) engine is provided, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

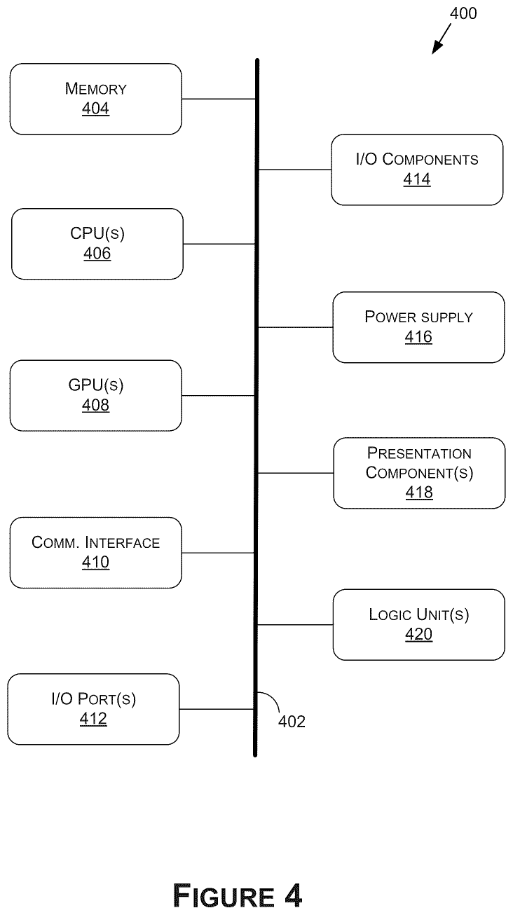

Content streaming system 100 of FIG. 1 includes application server(s) 102 (which may include similar components, features, and/or functionality to the example computing device 400 of FIG. 4), client device(s) 104 (which may include similar components, features, and/or functionality to the example computing device 400 of FIG. 4), and network(s) 106 (which may be similar to the network(s) described herein). In system 100 may be implemented to handle application sessions of an application. An application can be a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 100, for an application session, the client device(s) 104 may only receive input data in response to inputs to the input device(s), transmit the input data to the application server(s) 102, receive encoded display data from the application server(s) 102, and display the display data on the display 124. As such, the more computationally intense computing and processing is offloaded to the application server(s) 102 (e.g., rendering—in particular ray or path tracing—for graphical output of the application session is executed by the GPU(s) of the game server(s) 102). In other words, content of the application session (e.g., frames generated by the application during the application session) are streamed to the client device(s) 104 from the application server(s) 102, thereby reducing the requirements of the client device(s) 104 for graphics processing and rendering.

For example, with respect to an instantiation of an application session, a client device 104 may be displaying a frame of the application session on the display 124 based on receiving the display data from the application server(s) 102. The client device 104 may receive an input to one of the input device(s) and generate input data in response. The client device 104 may transmit the input data to the application server(s) 102 via the communication interface 120 and over the network(s) 106 (e.g., the Internet), and the application server(s) 102 may receive the input data via the communication interface 118. The CPU(s) may receive the input data, process the input data, and transmit data to the GPU(s) that causes the GPU(s) to generate a rendering of the content of the application session. For example, the input data may be representative of a movement of a character of the user in a game session of a game application, firing a weapon, reloading, passing a ball, turning a vehicle, etc.

The rendering component 112 may render the content of the application session (e.g., representative of the result of the input data) and the render capture component 114 may capture the rendering of the content of the application session as display data (e.g., as image data capturing the rendered frame of the application session). The rendering of the application session content may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 102. In some embodiments, one or more virtual machines (VMs)—e.g., including one or more virtual components, such as vGPUs, vCPUs, etc.—may be used by the application server(s) 102 to support the application sessions. The encoder 116 may then encode the display data to generate encoded display data and the encoded display data may be transmitted to the client device 104 over the network(s) 106 via the communication interface 118. The client device 104 may receive the encoded display data via the communication interface 120 and the decoder 122 may decode the encoded display data to generate the display data. The client device 104 may then display the display data via the display 124.

The application server(s) 102 may further include a QoS management engine 150. The QoS management engine 150 is configured to adjust a baseline QoS policy for the application session in response to the presence of a client-based network event on network(s) 106. The QoS management engine 150 may include a baseline QoS policy. As previously described, the baseline QoS policy can be used to control various parameters of the application server(s) 102, such as video bitrate, forward-error-correct (FEC) percentage, packet pacing, jitter buffer, etc.

The client device 104 periodically obtains performance indicators of network(s) 106. Performance indicators of network(s) 106 may refer to measurable metrics used to assess the efficiency, reliability, and quality of service provided by network(s) 106. Example of performance indicators can include, among others, one way delay, packet loss, network queue depth, network bandwidth, round-trip time (RTT) (commonly referred to as latency), throughput, jitter, error rates, congestion levels, availability, utilization, etc. In some embodiments, packet arrival timings and/or packet loss rates may be used to derive one way delay, throughput, network queue depth, bandwidth, latency, etc.

The performance indicators of network(s) 106 may be constantly transmitted to the QoS management component 150. Using the performance indicators of network(s) 106 received from the client device 104, the QoS management engine 150 can detect whether a client-based network event has occurred on network(s) 106. In particular, QoS management engine 150 may include a signature detection lookup data structure (e.g., a table, a file, etc.) which includes a plurality of entries. Each entry of the signature detection lookup data structure may include a predefined signature and a mathematical model. Each entry, which includes a predefined signature and a mathematical model, may correspond to a client-based network event that may occur on network(s) 106. Examples of client-based network events that may occur on network(s) 106 can include, among others, competing traffic, network queue depth, WLAN scans, ISP throttling, IP transit, etc. Competing traffic refers to a situation where multiple devices or applications are attempting to use the network's resources simultaneously, leading to congestion and potential performance degradation. Examples of applications that may cause competing traffic during the application session include applications for network performance measurement and tuning, video streaming applications, media download applications, file transfer applications, etc.

Each mathematical model of the signature detection lookup data structure can be empirically formulated to detect whether a client-based network event associated with the entry has occurred on network(s) 106 (e.g., resulting in a binary decision such as true or false). This is achieved by analyzing historical data, such as sample performance indicators, for patterns, trends, and relationships pertaining to the specific client-based network event that has occurred on a similar network. In some embodiments, the mathematical model may indicate a likelihood of the client-based network event associated with the entry having occurred on network(s) 106 (a value ranging from “0” to “1”).

In an example, a mathematical model used to detect whether competing traffic has occurred on network(s) 106 can be represented as the following:
(1) Competing Traffic Signature=((Bitrate_{OWD}>Bitrate_{OWD} Threshold) OR (Bitrate_{PL}>Bitrate_{PL}Threshold)) AND (BWE_{KURTOSIS}<BWE_{KURTOSIS} Threshold)
where Bitrate_{OWD} refers to a frequency in which a streaming bitrate is reduced in response to an increase in one way delay (OWD) within in a fixed time window, Bitrate_{PL} refers to a frequency in which a streaming bitrate is reduced in response to an increase in packet loss (PL) within in a fixed time window, and BWE_{KURTOSIS} refers to statistical measurements that quantifies the “peak” and/or “tail” of a bandwidth estimation distribution within a fixed time window, specifically in comparison to the normal distribution. Bandwidth estimation distribution refers to the statistical distribution or model used to estimate the available bandwidth in a computer network. As previously described, the mathematical model was empirically formulated which includes the selection of the Bitrate_{OWD} Threshold, the Bitrate_{PL} Threshold, and the BWE_{KURTOSIS} Threshold.

In another example, the mathematical model used to detect whether competing traffic is present on network(s) 106 can be represented as the following, instead of mathematical model (1):
(2) Competing Traffic Signature=(min(Bitrate_{OWD} Scale, Bitrate_{PL} Scale, BWE_{KURTOSIS} Scale)>Competing Traffic Probability Threshold)
where, Bitrate_{OWD} Scale is min(Bitrate_{OWD}/Bitrate_{OWD} Threshold, 1.0), Bitrate_{PL} Scale is min(Bitrate_{PL}/Bitrate_{PL}Threshold, 1.0), and BWE_{KURTOSIS} Scale is min(BWE_{KURTOSIS} Threshold/BWE_{KURTOSIS}, 1.0). The Competing Traffic Probability Threshold may be empirically chosen based on various aspects of the historical data to compensate for false positives and/or negatives.

For each frame of the application session, QoS management engine 150 can obtain a mathematical model from a respective entry of the signature detection lookup data structure. The performance indicators of network(s) 106, received from the client device 104, can be used as input to the mathematical model of the respective entry. In some embodiments, in which the mathematical models produce a binary decision output, if output of the mathematical model of the respective entry is “true,” the QoS management engine 150 selects the predefined signature of the respective entry. Thus, the QoS management engine 150 can determine that the specific client-based network event associated with the respective entry has occurred on network(s) 106. In other embodiments, in which the output of the mathematical models is a value between “0” and “1”, the QoS management engine 150 compares output values associated with entries of the signature detection lookup data structure, and selects the predefined signature of the entry having the largest output value.

Using the selected predefined signature, the QoS management engine 150 can query a configuration override lookup data structure (e.g., a table, a file, etc.) to obtain a set of overriding configuration properties used to modify a baseline QoS policy. The configuration override lookup data structure includes a plurality of entries. Each entry of the configuration override lookup data structure may include a predefined signature and a set of overriding configuration properties. The set of overriding configuration properties includes one or more overriding configuration properties each having a configuration parameter identifier referencing a configuration parameter of the baseline QoS policy to be overridden and a configuration parameter value to replace a value of the respective baseline QoS policy configuration parameter. Each configuration parameter may be empirically chosen based on various aspects of the historical data and adjustments made to the configuration parameter to be overridden to compensate for an effect of the selected predefined signature associated with a detected client-based network event. Additionally, each configuration parameter value may not only compensate for the effect of the selected predefined signature associated with the detected client-based network event, but also inherently improve one or more performance indicators used to detect the client-based network event and select a corresponding predefined signature.

The QoS management engine 150 can identify an entry that includes a predefined signature matching the selected predefined signature. Thus, a set of overriding configuration properties can be obtained from the matching entry to be used in compensating for the effects of a client-based network event associated with the selected predefined signature on network(s) 106.

In at least one embodiment, the selected predefined signature may be a competing traffic signature. The QoS management engine 150 can query the configuration override lookup data structure to identify a matching entry (e.g., an entry for the competing traffic signature). The matching entry may include a set of overriding configuration properties to be used in modifying the baseline QoS policy to compensate for the effects of competing traffic on network(s) 106. The set of overriding configuration properties associated with competing traffic signature can include a configuration override for OWD threshold, consecutive high OWD frames threshold, PL threshold, maximum FEC percentage, etc.

The OWD threshold may refer to a configuration parameter used to mark frames with high OWD as a high OWD frame. Accordingly, the configuration override for OWD threshold may include an identifier referencing OWD threshold and a configuration parameter value higher than a default value of the OWD threshold to compensate for the effects of competing traffic on network(s) 106. The consecutive high OWD frames threshold may refer to a number of consecutive high OWD frames that can be tolerated before reducing the bitrate. Accordingly, the overriding configuration property for consecutive high OWD frames threshold may include an identifier referencing consecutive high OWD frames threshold and a configuration parameter value higher than a default value of the consecutive high OWD frames threshold to compensate for the effects of competing traffic on network(s) 106.

The PL threshold may refer to a configuration parameter used to mark frames with high PL as a high PL frame. Accordingly, the configuration override for PL threshold may include an identifier referencing PL threshold and a configuration parameter value higher than a default value of the PL threshold to compensate for the effects of competing traffic on network(s) 106. The maximum FEC percentage refers to a maximum value that can be tolerated for the FEC percentage. Accordingly, the overriding configuration property for PL threshold may include an identifier referencing maximum FEC percentage and a configuration parameter value higher than a default value of the maximum FEC percentage to compensate for the effects of competing traffic on network(s) 106.

The QoS management engine 150 may determine whether to apply the set of overriding configuration properties associated with the selected predefined signature to the baseline QoS policy. More specifically, based on a mode of the QoS management component 150, the QoS management engine 150 can determine whether to apply the set of overriding configuration properties associated with the selected predefined signature to the baseline QoS policy. For example, the QoS management engine 150 can operate in an active mode or a passive mode. The QoS management engine 150, operating in passive mode, can detect a presence of a client-based network event and obtain a corresponding set of overriding configuration properties but not apply it to the baseline QoS policy. The QoS management engine 150, operating in active mode, can detect a presence of a client-based network event, obtain a corresponding set of overriding configuration properties, and apply the set of overriding configuration properties to the baseline QoS policy.

If the QoS management engine 150 determines that the set of overriding configuration properties associated with the selected predefined signature is to be applied to the baseline QoS policy, the QoS management engine 150 can apply the set of overriding configuration properties to the baseline QoS policy. In some embodiments, the QoS management engine 150 retrieves a default configuration file associated with the baseline QoS policy. The default configuration file may include a set of configuration parameters that define how the baseline QoS policy should be applied or enforced by the application server(s) 102 to ensure the high-quality user experience. The QoS management engine 150 can generate a copy of the default configuration file designated as an updated configuration file.

The QoS management component 150, using the set of overriding configuration properties, can modify one or more configuration parameters in the updated configuration file. For example, the QoS management engine 150 identifies a configuration parameter in the updated configuration file using an identifier of an overriding configuration property of the set of overriding configuration properties (e.g., identified configuration parameter of the updated configuration file). The QoS management engine 150 replaces a configuration parameter value of the identified configuration parameter of the updated configuration file with a configuration parameter value of a configuration parameter value of the overriding configuration property. The QoS management engine 150 repeats this for each overriding configuration property of the set of overriding configuration properties. Once each overriding configuration property of the set of overriding configuration properties is used to modify the updated configuration file, the QoS management engine 150 causes the updated configuration file defining an updated QoS policy to be applied or enforced by the application server(s) 102. The updated QoS policy compensates for the effects of a client-based network event associated with the selected predefined signature on network(s) 106 and ensures the high-quality user experience.

In some embodiments, the QoS management engine 150 may cause the application server(s) 102 to apply the updated QoS policy for a predetermined number of frames. Once the predetermined number of frames is reached, the QoS management engine 150 can cause the default configuration file defining the baseline QoS policy to be applied or enforced by the application server(s) 102 for each frame after the predetermined number of frames. Thus, the baseline QoS policy can be applied or enforced by the application server(s) 102 until the QoS management engine 150 detects a client-based network event. As a result, the QoS management engine 150 is able to apply the updated QoS policy in bursts (e.g., the predetermined number of frames) to address short-term durations of the client-based network event associated with the selected predefined signature on network(s) 106 and repeat it to add long-term durations of the client-based network event associated with the selected predefined signature on network(s) 106.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing light transport simulation, systems for performing collaborative content creation for 3D assets, systems implemented at least partially using cloud computing resources, and/or other types of systems.

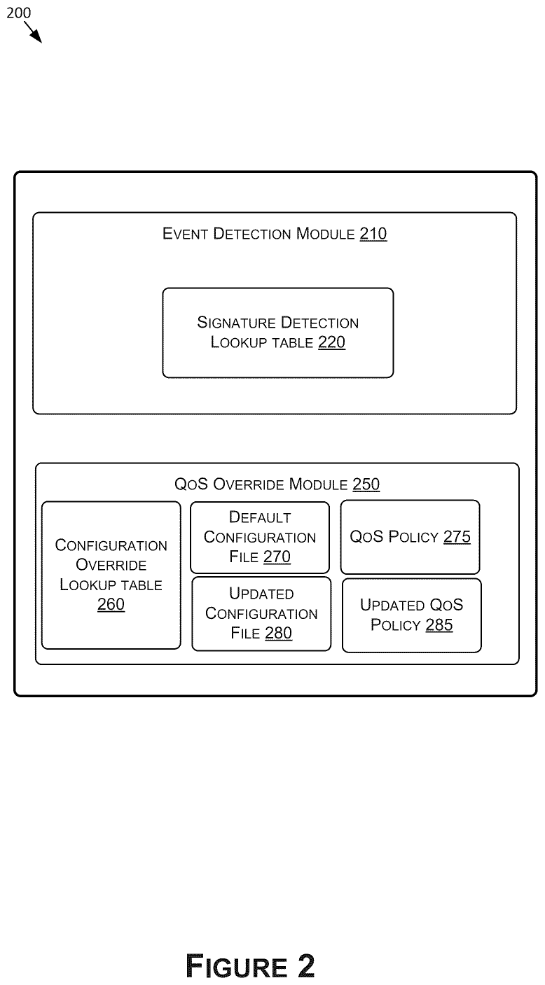

FIG. 2 is a block diagram of an example QoS management engine 200, in accordance with at least one embodiment. QoS management engine 200 may be similar to QoS management engine 150 of FIG. 1. QoS management engine 200 may include an event detection module 210 and a QoS override module 250.

The event detection module 210 periodically receives a plurality of performance indicators of a network from a client device. For each frame of the application session, the event detection module 210 iterates through a signature detection lookup table 220 to provide one or more performance indicators of the plurality of performance indicators as input to a mathematical model of a respective entry of the signature detection lookup table 220. If the output of the mathematical model of the respective entry of the signature detection lookup table 220 is true, the event detection module 210 selects a predefined signature of the respective entry of the signature detection lookup table 220, which indicates that a specific client-based network event (e.g., a type of detected network event) associated with the respective entry is present on the network.

As previously described, in some embodiments, an output of each mathematical model in an entry of the signature detection lookup table 220 is obtained, and a corresponding predefined signature of the output with the highest output is selected.

The QoS override module 250, using the selected predefined signature, queries a configuration override lookup table 260 to obtain a set of overriding configuration properties used to modify a QoS policy 275. The QoS override module 250 identifies an entry that includes a predefined signature matching the selected predefined signature to obtain a corresponding set of overriding configuration properties. As previously described, the set of overriding configuration properties associated with the selected predefined signature can include an overriding configuration property for a configuration file of the QoS policy 275.

The QoS override module 250 may determine whether to apply the set of overriding configuration properties associated with the selected predefined signature to the QoS policy 275. In response to determining that the set of overriding configuration properties associated with the selected predefined signature is to be applied to the QoS policy 275, the QoS override module 250 retrieves a default configuration file 270 associated with the QoS policy 275. As previously described, the default configuration file 270 includes a set of configuration parameters that define how the QoS policy 275 should be applied or enforced to ensure the high-quality user experience. The QoS override module 250 generates a copy of the default configuration file 270 designated as an updated configuration file 280.

The QoS override module 250, using the set of overriding configuration properties, modifies one or more configuration parameters in the updated configuration file 280 by replacing each configuration parameter value of the configuration parameter in the updated configuration file 280 with a corresponding configuration parameter value of a configuration parameter value of the overriding configuration property. The QoS override module 250 causes the updated configuration file 280 to generate an updated QoS policy 285. The updated QoS policy 285 is applied or enforced to compensate for the effects of a client-based network event associated with the selected predefined signature to ensure the high-quality user experience. The QoS override module 250 applies the updated QoS policy 285 for a predetermined number of frames, and then reverts back to QoS policy 275 until a subsequent client-based network event is detected.

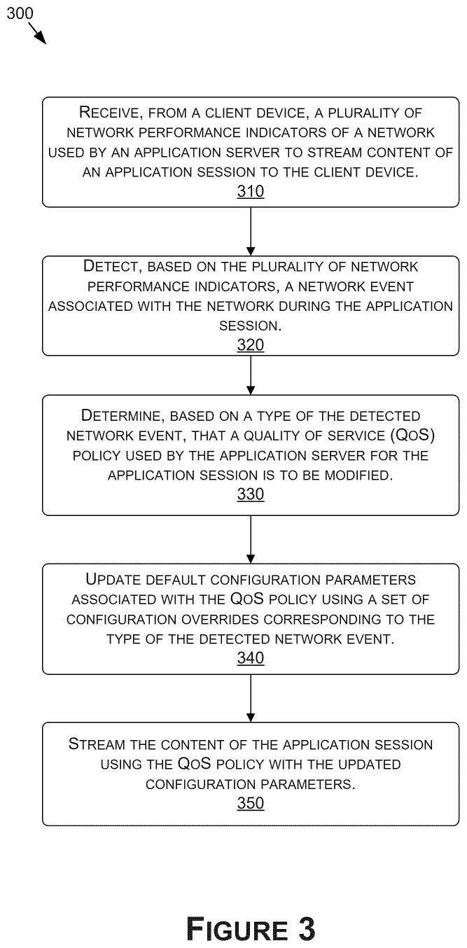

FIG. 3 depicts a flow diagram of an example method 300 for dynamically adjusting quality of service (QoS) policy for an application session, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 300 may be performed by a QoS management engine, such as the QoS management engine 150 in FIG. 1. Alternatively, some or all of method 300 might be performed by another module or machine. It should be noted that blocks depicted in FIG. 3 could be performed simultaneously or in a different order than that depicted.

At block 310, the processing logic receives, from a client device, a plurality of network performance indicators of a network used by an application server to stream content of an application session to the client device. The plurality of network performance indicators comprises one or more of: one way delay, packet loss, network queue depth, or network bandwidth. As previously described, the client device periodically obtains and transmits performance indicators of the network.

At block 320, the processing logic detects, based on the plurality of network performance indicators, a network event associated with the network during the application session. In some embodiments, detecting the network event associated with the network during (each frame of) the application session includes determining a type of the detected network event. In particular, the processing logic maintains a plurality of network event signatures each corresponding to a particular network event type of a plurality of network event types (e.g., a signature detection lookup table, as previously described). The processing logic calculates, for each of the plurality of network event types, a probability of occurrence of a respective network event type during the application session based on the plurality of network performance indicators and the plurality of network event signatures. The processing logic identifies a highest probability among calculated probabilities. The type of the detected network event corresponds to the highest probability.

In some embodiments, the calculation results in a binary decision. As previously described, the processing logic, for each frame of the application session, obtains, from each entry of a signature detection lookup table, a mathematical model of a respective entry and provides the received performance indicators as input to the mathematical model. If an output of the mathematical model is “true,” the processing logic selects a predefined signature of the respective entry which indicates that a specific client-based network event (e.g., a type of detected network event) associated with the respective entry is present on the network.

At block 330, the processing logic determine, based on a type of the detected network event, that a quality of service (QoS) policy used by the application server for the application session is to be modified. The type of detected network event may be a wireless local area network (WLAN) scan, internet service provider (ISP) throttling, internet protocol (IP) transit, or presence of one or more additional application sessions.

At block 340, the processing logic update default configuration parameters associated with the QoS policy using a set of overriding configuration properties corresponding to the type of the detected network event. In some embodiments, updating the configuration parameters associated with the QoS policy may include adjusting, using the set of overriding configuration properties, a plurality of default configuration parameters. In some embodiments, as previously described, the processing logic retrieves a default configuration file that includes the plurality of default configuration parameters associated with the QoS policy. The processing logic generates a copy of the default configuration file designated as an updated configuration file. The processing logic, using the set of overriding configuration properties, modifies one or more configuration parameters in the updated configuration file by replacing each configuration parameter value of the configuration parameter in the updated configuration file with a corresponding configuration parameter value of a configuration parameter value of the overriding configuration property.

At block 350, the processing logic streams the content of the application session using the QoS policy with the updated configuration parameters (or the updated configuration file). Upon streaming the content of the application session using the QoS policy with updated configuration parameters (or an updated QoS policy defined by the updated configuration file) for a predetermined number of frames, the processing logic may reinstate the QoS policy with the default configuration parameters and use the reinstated QoS policy until the QoS policy is modified due to a new network event.

### Example Computing Device

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Data Center

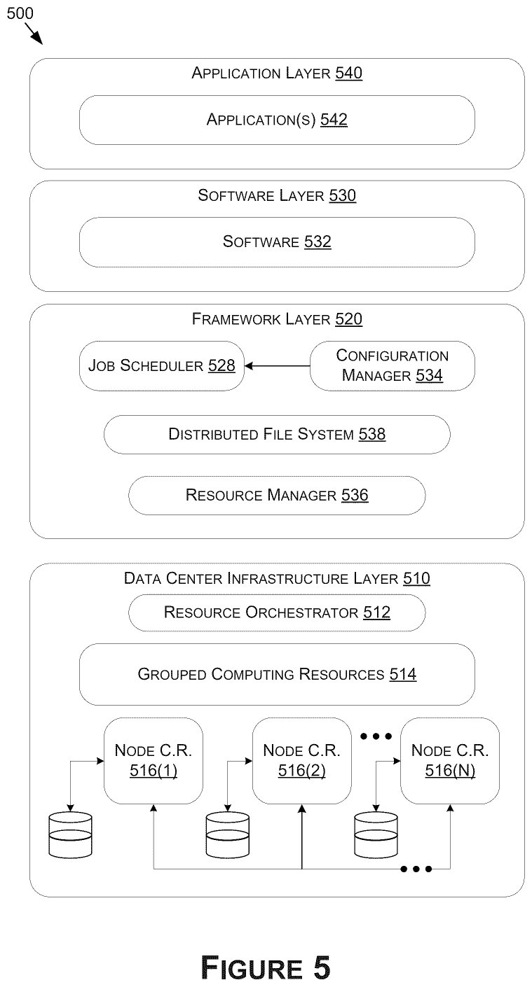

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory, or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving, from a client device, a plurality of network performance indicators of a network used by an application server to stream content of an application session to the client device;
detecting, based on the plurality of network performance indicators, a network event associated with the network during the application session;
determining, based on a type of the detected network event, that a quality of service (QoS) policy used by the application server for the application session is to be modified;
updating default configuration parameters associated with the QoS policy using a set of overriding configuration properties corresponding to the type of the detected network event; and
streaming the content of the application session using the QoS policy with the updated configuration parameters.

2. The method of claim 1, wherein the plurality of network performance indicators comprises one or more of: one way delay, packet loss, network queue depth, or network bandwidth.

3. The method of claim 1, wherein the type of detected network event is one of: a wireless local area network (WLAN) scan, internet service provider (ISP) throttling, internet protocol (IP) transit, or presence of one or more additional application sessions.

4. The method of claim 1, wherein determining the type of the detected network event comprises:
maintaining a plurality of network event signatures each corresponding to a particular network event type of a plurality of network event types;
calculating, for each of the plurality of network event types, a probability of occurrence of a respective network event type during the application session based on the plurality of network performance indicators and the plurality of network event signatures; and
identifying a highest probability among calculated probabilities, wherein the type of the detected network event corresponds to the highest probability.

5. The method of claim 1, wherein the set of overriding configuration properties is obtained by querying a configuration override lookup table using the type of the detected network event, wherein the configuration override lookup table comprises a plurality of entries each including a network event type and a corresponding set of overriding configuration properties.

6. The method of claim 1, wherein updating the configuration parameters associated with the QoS policy comprises:
adjusting, using the set of overriding configuration properties, the default configuration parameters.

7. The method of claim 1, further comprising:
upon streaming the content of the application session using the QoS policy with updated configuration parameters for a predetermined number of frames, reinstating the QoS policy with the default configuration parameters; and
using the reinstated QoS policy until the QoS policy is modified due to a new network event.

8. A processor comprising:
one or more circuits to:
receive, from a client device, a plurality of network performance indicators of a network used by an application server to stream content of an application session to the client device;
detect, based on the plurality of network performance indicators, a network event associated with the network during the application session;
determine, based on a type of the detected network event, that a quality of service (QoS) policy used by the application server for the application session is to be modified;
update default configuration parameters associated with the QoS policy using a set of overriding configuration properties corresponding to the type of the detected network event; and
stream the content of the application session using the QoS policy with the updated configuration parameters.

9. The processor of claim 8, wherein the plurality of network performance indicators comprises one or more of: one way delay, packet loss, network queue depth, or network bandwidth.

10. The processor of claim 8, wherein the type of detected network event is one of: a wireless local area network (WLAN) scan, internet service provider (ISP) throttling, internet protocol (IP) transit, or presence of one or more additional application sessions.

11. The processor of claim 8, wherein determining the type of the detected network event comprises:
maintain a plurality of network event signatures each corresponding to a particular network event type of a plurality of network event types;
calculate, for each of the plurality of network event types, a probability of occurrence of a respective network event type during the application session based on the plurality of network performance indicators and the plurality of network event signatures; and
identify a highest probability among calculated probabilities, wherein the type of the detected network event corresponds to the highest probability.

12. The processor of claim 8, wherein the set of overriding configuration properties is obtained by querying a configuration override lookup table using the type of the detected network event, wherein the configuration override lookup table comprises a plurality of entries each including a network event type and a corresponding set of overriding configuration properties.

13. The processor of claim 8, wherein updating the configuration parameters associated with the QoS policy comprises:
adjusting, using the set of overriding configuration properties, the default configuration parameters.

14. The processor of claim 8, wherein the one or more circuits is to further:
upon streaming the content of the application session using the QoS policy with updated configuration parameters for a predetermined number of frames, reinstate the QoS policy with the default configuration parameters; and
use the reinstated QoS policy until the QoS policy is modified due to a new network event.

15. A system comprising:
one or more processing units; and
one or more memory units storing instructions that, when executed by the one or more processing units, cause the one or more processing units to execute operations comprising:
receiving, from a client device, a plurality of network performance indicators of a network used by an application server to stream content of an application session to the client device;
detecting, based on the plurality of network performance indicators, a network event associated with the network during the application session;
determining, based on a type of the detected network event, that a quality of service (QoS) policy used by the application server for the application session is to be modified;
updating default configuration parameters associated with the QoS policy using a set of overriding configuration properties corresponding to the type of the detected network event; and
streaming the content of the application session using the QoS policy with the updated configuration parameters.

16. The system of claim 15, wherein the plurality of network performance indicators comprises one or more of: one way delay, packet loss, network queue depth, or network bandwidth.

17. The system of claim 15, wherein the type of detected network event is one of: a wireless local area network (WLAN) scan, internet service provider (ISP) throttling, internet protocol (IP) transit, or presence of one or more additional application sessions.

18. The system of claim 15, wherein determining the type of the detected network event comprises:
maintaining a plurality of network event signatures each corresponding to a particular network event type of a plurality of network event types;
calculating, for each of the plurality of network event types, a probability of occurrence of a respective network event type during the application session based on the plurality of network performance indicators and the plurality of network event signatures; and
identifying a highest probability among calculated probabilities, wherein the type of the detected network event corresponds to the highest probability.

19. The system of claim 15, wherein the set of overriding configuration properties is obtained by querying a configuration override lookup table using the type of the detected network event, wherein the configuration override lookup table comprises a plurality of entries each including a network event type and a corresponding set of overriding configuration properties.

20. The system of claim 15, wherein updating the configuration parameters associated with the QoS policy comprises:
adjusting, using the set of overriding configuration properties, the default configuration parameters.
